(19) United States
(12) Patent Application Publication
(10) Pub. No.: US 2026/0277773 A1
(43) Pub. Date: Sep. 17, 2026

(54) TEST CASE GENERATION SYSTEM

(71) Applicant: Oracle International Corporation, Redwood Shores, CA (US)

(72) Inventors: Charles Barathidass, San Jose, CA (US); Karthik Namburu, Leander, TX (US)

(73) Assignee: Oracle International Corporation, Redwood Shores, CA (US)

(21) Appl. No.: 19/346,325

(22) Filed: Sep. 30, 2025

Related U.S. Application Data
(60) Provisional application No. 63/772,146, filed on Mar. 14, 2025.

(51) Int. Cl. G06F 11/3668

(52) U.S. Cl. CPC G06F 11/3684; G06F 11/3696

(57) ABSTRACT

A test case generation system is disclosed that is capable of generating end-to-end (E2E) test cases for dynamically evolving user interface (UI) structures associated with services and applications executing in a distributed computing environment. The system obtains a UI screen to be tested. The UI screen may represent a physical and visual point of contact for a user to interact with an application or service. The test case generation system then generates a prompt (i.e., a set instructions) to be used for generating a set of test cases that are applicable for testing the UI screen. The prompt is provided by the test case generation system as input to a machine learning (ML) model. The ML model generates a set of test cases for the UI screen to be tested. The test cases output by the ML model are executed in a test execution platform to test the UI screen.

### CROSS-REFERENCES TO RELATED APPLICATIONS

This application is a non-provisional application of and claims the benefit and priority under 35 U.S.C. 119(e) of U.S. Provisional Application No. 63/772,146, filed Mar. 14, 2025, entitled “Rapid E2e Test Generation And Mitigating Hallucination Using Generative Artificial Intelligence,” the entire contents of which are incorporated herein by reference for all purposes.

### BACKGROUND

Software testing generally refers to the process of evaluating and verifying the functionality, performance, and reliability of software applications and services. The applications and services may operate across multiple interconnected systems. End to end testing (E2E testing) refers to a type of software testing methodology that involves testing the workflow of an application or service from beginning to end. E2E testing is especially critical for ensuring software reliability in distributed computing systems, and in systems that are characterized by rapid release cycles and adaptive architectures. However, testing of distributed systems remains a challenge because of rapidly evolving service architectures and growing test maintenance requirements of various services and applications across multiple components within the distributed system.

Various approaches have been adopted to generate E2E test cases for distributed computing environments. One common approach involves the formulation of manual test cases that can be used to test the functionality of various workflows (e.g., user flows, data consistency flows, data integration flows and so on) of applications and services operating across interconnected components in a distributed computing environment. Although manual test case formulation ensures precision, it is inherently labor intensive, prone to errors, and lacks scalability. Another commonly used testing methodology to generate E2E test cases in distributed environments is template-based test generation, which relies on constructing predefined templates to generate E2E test cases. However, template-based test generation also requires significant manual setup and frequent adjustments owing to user interface structural changes and manual configuration updates which may occur as a result of a user's interaction with services and applications executing within the distributed computing environment. These frequent adjustments may result in extended development cycles that can typically span several months. Template-based test generation also suffers from low adoption owing to its complexity. For instance, a team may spend weeks configuring templates for a single service, only to have changes in the service implementation break the templates.

Certain other approaches have been developed that utilize AI-based solutions to automate the generation of test cases in distributed systems. However, current AI-based solutions generally lack capabilities to effectively test evolving UI structures in services and applications executing in distributed systems. UI structures represent primary interfaces through which users typically interact with services and applications. These UI structures maybe constantly evolving in real-time based on the user's behavior, intent, or interaction with UI elements that are part of the UI interface structure. However, existing AI-based tools currently lack capabilities to predict the dynamically changing behavior of these UI elements and often misidentify these UI elements, resulting in the generation of unreliable test cases and increased manual validation efforts to validate the test cases. There is thus a need for developing techniques that improve the efficiency and accuracy of generating test cases for distributed computing environments than what is possible by existing implementations.

### BRIEF SUMMARY

This disclosure relates generally to test case generation in distributed computing environments and, more particularly, to a test case generation system that includes capabilities for generating end-to-end (E2E) test cases for dynamically evolving user interface (UI) structures associated with services and applications executing in a distributed computing environment.

In certain embodiments, a test case generation system is disclosed. The test case generation system obtains a UI screen to be tested and determines code for implementing the UI screen. The system determines a category for the UI screen based on content associated with the UI screen and determines reference UI data corresponding to the category of the UI screen to be tested. The system then generates a prompt to be used for generating a set of test cases for the UI screen to be tested and provides the prompt as input to a machine learning (ML) model to generate a set of test cases for the UI screen to be tested. The system then causes the execution of the set of test cases generated by the ML model to test the UI screen to be tested, where the set of test cases are executed in a test execution platform.

In certain examples, the reference UI data is associated with a reference UI screen, and the reference UI screen belongs to the category determined for the UI screen to be tested. In certain examples, the reference UI data is associated with a reference UI screen, and the reference UI screen is different from the UI screen to be tested. In certain examples, the reference UI screen is associated with a first cloud service and the UI screen to be tested is associated with a second cloud service, and wherein the first cloud service is different from the second cloud service.

In certain examples, a category of the reference UI screen corresponds to the category of the UI screen to be tested, and the category corresponds to at least one of a listing UI category, a details UI category, a create/update UI category or a delete UI category. In certain examples, the first cloud service and the second cloud service represent one or more services subscribed to by a user of the test generation system. In certain examples, the reference UI screen represents a first UI screen associated with a first cloud service and the UI screen to be tested represents a second UI screen associated with the first cloud service, and a category of the reference UI screen corresponds to the category of the UI screen to be tested.

In certain examples, generating the prompt to be used for generating the set of test cases for the UI screen to be tested comprises selecting, by the test case generation system, a prompt template. The selected prompt template comprises an example UI input section, a test UI input section and a task request section.

In certain examples, generating the prompt to be used for generating the set of test cases for the UI screen to be tested comprises inserting, by the test case generation system, the reference UI data into the example UI input section of the prompt template and inserting, by the test case generation system, the code for implementing the UI screen to be tested into the test UI input section of the prompt template.

In certain examples, the example UI input section comprises (1) a code section comprising code implemented for the reference UI data, (2) a tests section specifying a set of test cases for the reference UI data, wherein the reference UI data is associated with a reference UI screen, and wherein the reference UI screen belongs to the category determined for the UI screen to be tested and (3) a tests outputs section identifying outputs from executing the set of test cases in the tests section.

In certain examples, the tests section in the example UI input section of the prompt template comprises a list of abstract classes, where the list of abstract classes define a functionality and one or more properties associated with one or more related UI elements identified in the reference UI data.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example computing environment including a test case generation system that is configured to generate end-to-end (E2E) test cases for testing evolving UI structures associated with services and applications executing in a distributed computing environment, according to certain embodiments.

FIG. 2 depicts an example of a process for generating test cases for a UI screen, according to certain embodiments.

FIG. 3 illustrates an example configuration for a prompt template that is used to generate a set of test cases for a UI screen to be tested, according to certain examples.

FIG. 4 illustrates an example configuration for a tests section in a prompt template that is used to generate a set of test cases for a UI screen to be tested, according to certain examples.

FIG. 5 illustrates an example of a test case generated by the ML model to test a UI screen, according to certain embodiments.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

This disclosure relates generally to test case generation in distributed computing environments and, more particularly, to a test case generation system that includes capabilities for generating end-to-end (E2E) test cases for dynamically evolving UI structures associated with services and applications executing in a distributed computing environment.

As described in the Background section, existing approaches for generating test cases for distributed computing environments (e.g., large-scale software environments) suffer from certain drawbacks. With the advent of AI-based solutions, the efficiency and accuracy of test case generation has significantly improved. For example, certain AI-based solutions may utilize techniques such as chain-of-thought (CoT) prompting to significantly improve the accuracy of generating test cases. Chain-of-Thought (CoT) prompting refers to a technique that enhances the reasoning capability in machine learning (ML) models (e.g., large language models (LLMs)) by instructing them to show their intermediate steps, or “chain of thought,” to arrive at a final answer. However, as noted above, such AI-based techniques can also suffer from certain drawbacks. For example, current AI-techniques lack the capability to predict the dynamically changing behavior of UI elements and often tend to misidentify such UI elements in web pages or UI screens. For instance, UI elements in a UI screen can dynamically change when, for example, a UI element frequently changes its position or suddenly moves around after content is already displayed, or when content (e.g. images, videos, fonts) is loaded in a UI screen at different times. Some AI-based solutions attempt to directly reference the underlying Hyper Text markup Language (HTML) element in the Document Object Model (DOM) structure to identify the UI element, but directly referencing the HTML DOM structure can cause the underlying DOM structure to become unstable, especially when the DOM comprises deeply nested HTML elements. The misidentification of such UI elements can cause unstable and unreliable test cases to be generated and in turn, can result in increased manual validation efforts by the AI models.

To address these challenges, among others, techniques are described herein for generating end-to-end (E2E) test cases for dynamically changing and dynamically evolving UI structures associated with services and applications executing in a distributed computing environment. According to examples described herein, a test case generation system is described that obtains a UI screen to be tested. The UI screen may be associated with an application or a service. The UI screen may represent a physical and visual point of contact for a user to interact with an application or service. For instance, the user may interact with a UI screen of a service or application to navigate, complete tasks and achieve desired outcomes within the service or application.

The test case generation system then generates a prompt (i.e., a set instructions) to be used for generating a set of test cases that are applicable for testing the UI screen. In certain embodiments, the test generation system is configured with capabilities to generate different prompts, where each prompt that is generated is specific to a type of content provided by the UI screen being tested. For instance, a first UI screen for a service or application may represent a “listing UI screen” and may include content related to a service's overall architecture or configuration options. A second UI screen for the service or application may represent a “details UI screen” and may include content related to specific resources managed by the service, such as a virtual machines, databases, storage buckets. By generating customized prompts, the test case generation system is able to generate test cases that are relevant and applicable for testing different UI screens of a service or application executing in a distributed computing environment. The prompt is then provided by the test case generation system as input to a machine learning (ML) model. The ML model generates a set of test cases for the UI screen to be tested. The test cases output by the ML model are then executed in a test execution platform (e.g., Playwright) to test the UI screen.

In certain embodiments, the test case generation system may be configured with capabilities to integrate a list of abstract classes into the prompt to be used for generating a set of test cases for the UI screen to be tested. The list of abstract classes can be used to reference related UI elements identified in a UI screen and used to define the functionality and properties of related (or common) UI elements identified in the UI screen to be tested. For instance, the test generation system can utilize an abstract class to define common properties (e.g., text, color, position) and certain functionalities (e.g., onClick, onHover) that are shared across a group of related UI elements (e.g., different types of buttons) in a UI screen. The prompt that is integrated with abstract class definitions as described above serves as a dynamic template that can be used by the test case generation system to generate test cases for UI structures of services and applications. By incorporating abstract classes into the prompt, the set of test cases that are generated are able to dynamically adapt to evolving UI structures, thereby enabling more scalable, dynamic, and rapid, on-the-fly test case generation than what is possible by existing test generation techniques. Additionally, by tailoring the prompt to individual UI screens based on the type of content present in the UI screen, the disclosed technique is able to achieve more accurate test generation, enhance test reliability and maintainability, and effectively minimize manual intervention.

Existing approaches for performing test case generation lack structured abstraction mechanisms to accommodate evolving UI structures. In contrast, the disclosed technique incorporates abstract-class-based referencing and UI content-specific based prompting to address dynamic UI changes, reduce hallucination, and improve the accuracy of large-scale test generation across diverse cloud environments. Moreover, existing approaches that perform automatic E2E testing do not adequately address challenges such as hallucination arising from AI models that often tend to misidentify UI elements in UI structures, which results in the generation of test cases with lower accuracy. The disclosed technique addresses these challenges through a single-shot, UI content-specific based prompting technique coupled with abstract-class-based referencing to enable more robust and sustainable test cases to be generated in dynamic UI environments. The disclosed method automates E2E UI test case generation using structured prompts, abstract-class-based selectors, and configuration-driven inputs to enhance execution stability and test coverage in cloud-native environments and distributed computing environments.

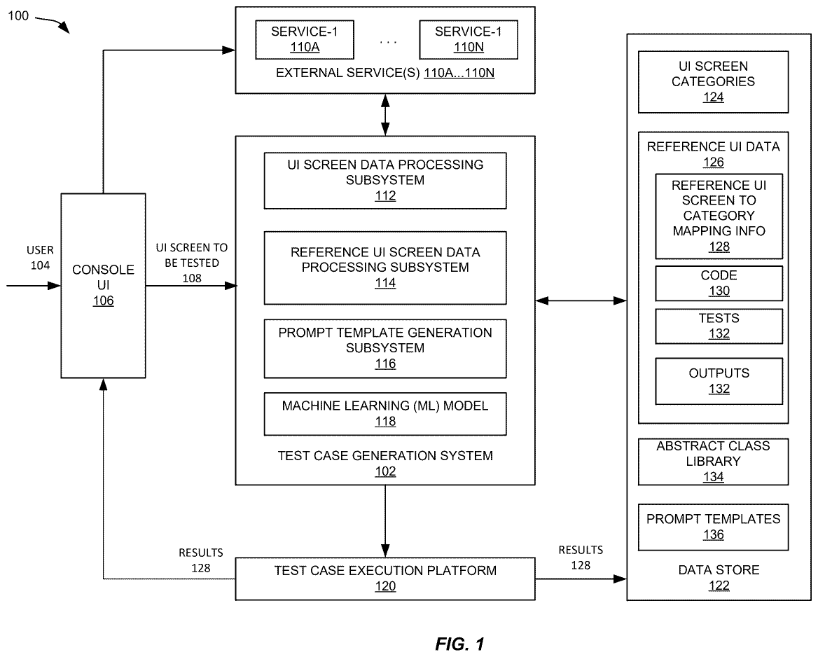

Referring now to the drawings, FIG. 1 depicts an example computing environment 100 including a test case generation system that is configured to generate end-to-end (E2E) test cases for testing evolving UI structures associated with services and applications executing in a distributed computing environment, as disclosed herein, according to certain embodiments. The test case generation subsystem 102 may be implemented by one or more computing systems. For example, the one or more computing systems may execute computer-readable instructions (e.g., code, program) to implement the test case generation system 102. As depicted in FIG. 1, the test case generation system 102 includes various subsystems including a UI screen data processing subsystem 112, a reference UI screen data processing subsystem 114, a prompt template generation subsystem 116 and a machine learning (ML) model 118. Portions of data or information used by or generated by the test case generation system 102 as part of its processing may be stored in a persistent memory such as data store 122. The computing environment 100 additionally includes a test case execution platform 120 for executing one or more test cases output by the ML model 118 to test the UI screen to be tested. The systems and subsystems depicted in FIG. 1 may be implemented using only software (e.g., code, instructions, program) executed by one or more processing units (e.g., processors, cores) of a computing system, hardware, or combinations thereof. The software may be stored on a non-transitory storage medium (e.g., on a memory device).

Computing environment 100 depicted in FIG. 1 is merely an example and is not intended to unduly limit the scope of claimed embodiments. One of ordinary skill in the art would recognize many possible variations, alternatives, and modifications. For example, in some implementations, the test case generation system 102 can be implemented using more or fewer subsystems than those shown in FIG. 1, may combine two or more subsystems, or may have a different configuration or arrangement of subsystems.

In certain examples, the subsystems of the test case generation system 102 may be provided by a cloud provider network (e.g., as part of a shared computing resource environment). In other examples, the subsystems of the test case generation system 102 may execute on computing devices managed within an on-premises datacenter or other distributed computing environment, or on computing devices located within a combination of cloud-based and on-premises computing environments. For instance, users of an enterprise may utilize the functionality of the test case generation system 102 to generate a set of test cases for a UI screen to be tested. In some other embodiments, the test case generation subsystem 102 may be implemented on one or more servers of a cloud service provider (CSP) and its test case generation functionality may be provided to subscribers (e.g., an organization or an enterprise) who subscribe to cloud services on a subscription basis.

As depicted in FIG. 1, a user 104 may interact with the test case generation system 102 using a console UI 106 of a user's computing device that is communicatively coupled to the test case generation system 102, possibly via one or more communication networks. The user device may be of various types, including but not limited to, a mobile phone, a tablet, a desktop computer, and the like. For example, the user 104 may interact with the test case generation system 102 by selecting a UI screen 108 to be tested via the console UI 106 and send a request to the test case generation system 102 to generate test cases for the UI screen. The UI screen 108 to be tested may be associated with an external service or application that the test case generation system 102 may interface with. In certain examples, the external services (110A . . . 110N) may represent any third-party service or cloud service that may be made available to the user on demand (e.g., via a subscription model) using systems and infrastructure (cloud infrastructure) provided by a cloud services provider.

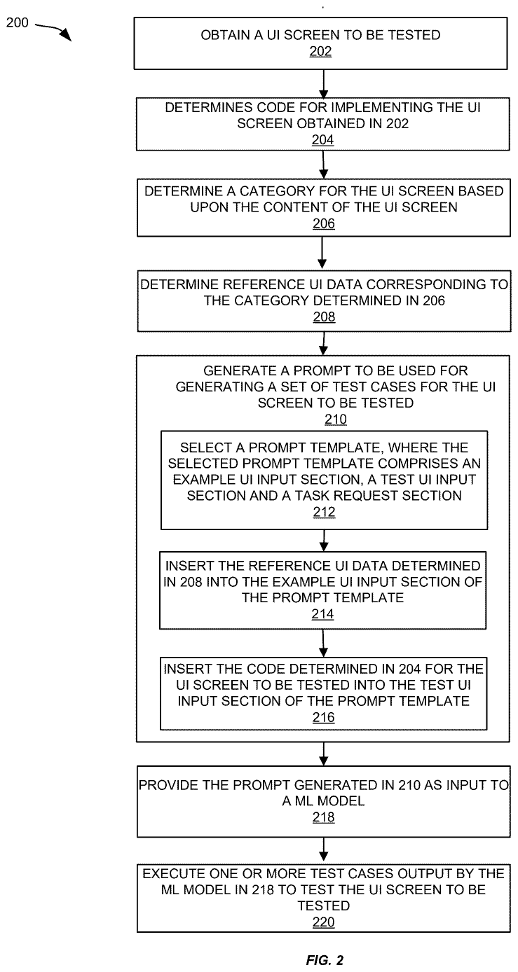

The UI screen 108 to be tested is then communicated from the console UI 106 of the user device to the test case generation system 102 for analysis. Upon receiving the request from the user device, the test case generation system 102 performs processing to generate a set of test cases to test the UI screen 108. The set of test cases generated by the test case generation system 102 are then executed by a test case execution platform 120. The results 128 (i.e., a set of test cases executed for the UI screen 108) are then communicated back to the requesting user device or stored in the data store 122. These results 128 may include a set of test cases executed for the UI screen to be tested, and possibly other information such as an execution result for each executed test case such as whether the test passed, failed, or was inconclusive, along with detailed logs, captured evidence like screenshots or videos, error messages, and a summary of defects included in the results. Details related to the processing performed by the various systems and subsystems in FIG. 1 for generating and executing a set of test cases for a UI screen are described below with respect to the flowchart depicted in FIG. 2 and the accompanying description.

FIG. 2 depicts an example of a process 200 for generating test cases for a UI screen, according to certain embodiments. The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 200 presented in FIG. 2 and described below is intended to be illustrative and non-limiting. Although FIG. 2 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 1, the processing depicted in FIG. 2 may be performed by the test case generation system 102. In certain embodiments, within the test case generation system 102, the processing in 202-220 may be performed by one or more subsystems (e.g., 112, 114, 116 and 118) of the test case generation system 102.

In the embodiment depicted in FIG. 2, processing is initiated when, in 202, a request is obtained requesting the generation of test cases for a UI screen to be tested. For example, the test case generation system 102 may receive a signal from the console UI of a user device indicating that a user of the user device has requested a particular UI screen to be analyzed for purposes of generating test cases that are applicable for the UI screen. For example, in the embodiment depicted in FIG. 1, a user 104 may use a console UI 106 of a user device to select a UI screen 108 for which applicable test cases are to be generated. This may then be communicated from the user device to the test case generation system 102 for further analysis. In certain examples, the UI screen 108 to be tested may be associated with an external service (e.g., 110A) that the user 104 of the test case generation system 120 subscribes to. Upon subscribing to a particular service, the user 104 may obtain a UI screen 108 to be tested from that particular service. As previously indicated, the external service may generally be provided by a third-party provider or a cloud service provider. For example, the external service may represent a cloud service such as a compute service, a storage service, a database service, a networking service and so on.

The UI screen to be tested can represent one of many different UI screen types based on the type of content presented by the UI screen. For instance, in certain examples, the UI screen may represent a listing UI screen (also described herein as a UI listing page) for a service that includes content related to a service's overall architecture or configuration options. In other examples, the UI screen may represent a details UI screen (also described herein as a UI details page) that includes content related to specific resources managed by the service, such as a virtual machines, databases, storage buckets and so on. Other examples of UI screens may include, but are not limited to, a create/update UI screen that includes content related to certain create or update operations that can be performed by resources used by a service, a delete UI screen that includes content related to delete operations performed on resources and so on. As previously indicated, a UI screen provides a physical and visual point of contact for a user to communicate with a particular service or application through which the user can navigate, complete tasks and achieve desired outcomes within the service or application.

At block 204, the test case generation system 102 determines code for implementing the UI screen obtained in block 202. In a certain implementation, a UI screen data processing subsystem 112 within the test case generation system 102 may perform the processing to determine the code for implementing the UI screen 108 to be tested. The processing performed in block 204 may involve, for example, scanning, by the UI screen data processing subsystem 112, the service (e.g., 110A) associated with the UI screen (e.g., 108) and selecting a set of UI files related to the UI screen from the final build generated by the service. In certain implementations, the UI files may correspond to Meta-Abstracted UI (MAUI) configuration files or Java Script Object Notation (JSON) configuration files. MAUI is a config-driven development framework that produces structured JSON representations of UI components. The system is compatible with any approach that generates machine-readable configuration files (JSON, YAML, XML) describing UI elements and their properties. The processing may further include, fetching the contents and code from the selected set of UI files related to the UI screen for further analysis by the subsystems of the test case generation system 102.

At block 206, the test case generation system 102 determines a category for the UI screen (e.g., 108) to be tested based upon the content of the UI screen. For instance, if the UI screen obtained in block 202 comprises content related to a listing UI page associated with a service as described above, then the test case generation system 102 may associate a “listing UI category” with the UI screen to be tested. In a similar manner, the test case generation system 102 may associate a “details UI category” with a UI screen that comprises content related to a details UI page and so on. In a certain implementation, the category for the UI screen to be tested may be determined by a reference UI screen data processing subsystem 114 within the test case generation system 102 from a list of pre-configured UI screen categories 124 stored in a data store 122 accessible to the test case generation system 102. The list of pre-configured UI screen categories 124 may include, but are not limited to, a listing UI category, a details UI category, a create/update UI category, a delete UI category and so on.

At block 208, the test case generation system 102 determines reference UI data corresponding to the category identified in 206. In a certain implementation, the reference UI data may be determined by the reference UI screen data processing subsystem 114 within the test case generation system 102. The reference UI data may be associated with a reference UI screen belonging to the category identified in block 206. For instance, if the category identified in block 206 is a “listing UI category,” then the test case generation system 102 may determine reference UI data that corresponds to the “listing UI category.” In a similar manner, if the category identified in block 206 is a “details UI category,” then the test case generation system 102 may determine reference UI data that corresponds to the “details UI category.” The reference UI data 126 may be stored in a data store 122 accessible to the test case generation system 102. In certain implementations, the reference UI data 126 may include information that identifies (1) mapping information 128 that maps a reference UI screen to a particular category, (2) a code section 130 comprising code for the reference UI screen that the reference UI data is associated with; (2) a tests section 132 specifying a set of one or more test cases written for the reference UI screen; and (3) an outputs section 132 identifying outputs from executing the one or more tests in the tests section. In certain examples, and as will be described in more detail hereinafter, the test generation system 102 may utilize the reference UI data 126 to generate a prompt to be used for generating a set of test cases for the UI screen to be tested.

In certain examples, the reference UI screen that the reference UI data 126 is associated with may be different from the UI screen 108 to be tested. For example, the reference UI screen may have been created for a first cloud service (e.g., a database service) and the UI screen 108 to be tested could be created for a second cloud service (e.g., a virtual networking service) that is different from the first cloud service. However, both the reference UI screen and the UI screen 108 to be tested may belong to the same category (e.g., a “listing UI” category). In other examples, the reference UI screen and the UI screen 108 to be tested could be two different UIs associated with the same service, where both the reference UI screen and the UI screen belong to the same category.

### Prompt Generation

According to certain examples described herein, upon determining reference UI data 126 as described above, at block 210, the test case generation system 102 may be configured generate a prompt to be used for generating a set of test cases for the UI screen to be tested. In certain implementations, the prompt may be generated by a prompt template generation subsystem 116 within the test case generation system 102. In certain examples, the prompt template generation subsystem 116 may be configured with capabilities to generate a customized prompt that can be used to generate a set of test cases for a particular UI screen to be tested. The customized prompt is generated based on identifying the content of the UI screen being tested. For instance, if the UI screen includes content related to a service's listing page as described above, then the prompt template generation subsystem 116 is configured to generate a customized prompt that can be used to generate test cases that are applicable to the listing page. In a similar manner, if the UI screen includes content related to a service's details page as described above, then the prompt template generation subsystem 116 can generate a customized prompt that can be used to generate test cases that are applicable to the details page.

The generation of a prompt that can be used to generate test cases that are applicable to a particular UI screen to be tested may involve multiple stages. In a first stage, at block 212, the prompt template generation subsystem 116 selects a prompt template from a list of prompt templates 136 stored in the data store 122. A prompt template, as described herein, may represent a reusable, pre-defined structure for crafting instructions or queries for a machine learning (ML) model to generate a set of test cases for the UI screen to be tested. In certain examples, the prompt template selected at block 212 may be composed of a set of sections, where each section in the set of sections represents a placeholder for dynamic information to be inserted into the section. A first section in the set of sections may represent an example UI input section for receiving reference UI data associated with a reference UI screen. As previously described, the reference UI screen may belong to a category associated with the UI screen to be tested. A second section in the set of sections may represent a test UI input section for receiving data (e.g., code) for the UI screen for which one or more tests are to be generated. A third section in the set of sections may represent a task request section instructing a ML model (e.g., a large language model (LLM)) to generate one or more tests for the UI screen to be tested.

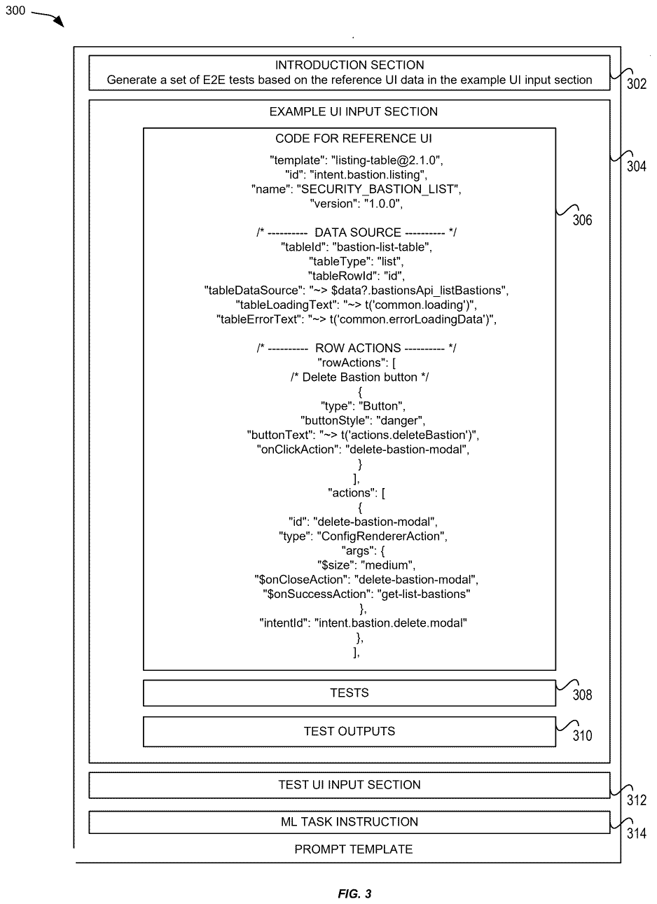

Upon selecting a prompt template as described above, in a second stage of processing, at block 214, the prompt template generation subsystem 116 populates the selected prompt template by inserting the reference UI data determined in 208 into the example UI input section of the prompt template. In a third stage of processing, at block 216, the prompt template generation subsystem 116 inserts the code determined in block 204 for the UI screen to be tested into the test UI input section of the prompt template. One such illustrative prompt template comprising a set of sections as described above is shown in FIG. 3. The specific configuration of the prompt template shown in FIG. 3 is intended to be illustrative in nature. For example, the specific content in the sections and the number of sections may vary according to embodiments of the present application. In some instances, one or more sections in the prompt template may be omitted or combined together. Other configurations of the prompt template are also possible.

FIG. 3 illustrates an example configuration for a prompt template that is used to generate a set of test cases for a UI screen to be tested, according to certain examples. In the example shown in FIG. 3, the prompt template 300 is composed of an introduction section 302, an example UI input section 304, a test UI input section 312 and an ML task instruction section 314. The introduction section 302 specifies the task the ML model is to perform. For example, the introduction section 302 might provide a brief description of the task to be performed by the ML model and any relevant information to guide the ML model's response in a desired format. The example UI input section 304 identifies reference UI data associated with a reference UI screen. As previously indicated, the reference UI screen belongs to a category associated with the UI screen to be tested. For instance, if the category associated with the UI screen to be tested is a “listing UI category,” then the reference UI data identified in the example UI input section is associated with a listing UI screen. In a similar manner, if the category associated with the UI screen to be tested is a “details UI category,” then the reference UI data identified in the example UI input section is associated with a details UI screen.

In certain implementations, the example UI input section 304 may be composed of one or more subsections that include (1) a code section 306 that comprises code for the reference UI data; (2) a tests section 308 specifying a set of one or more test cases written for the reference UI data; and (3) a tests outputs section 310 identifying outputs from executing test cases in the tests section. In the example of the prompt template illustrated in FIG. 3, the code section 306 in the example UI input section 306 comprises code for a “listing UI screen” for which one or more tests are to be generated. The specific configuration of the prompt template shown in FIG. 3 for a listing UI screen is intended to be illustrative in nature. For example, in other embodiments, the prompt template can be generated for different types of UI screens described in this disclosure such as a details UI screen, a create/update UI screen, a delete UI screen and so on.

In the example shown in FIG. 3, the code section 306 for the “listing UI screen” identifies a listing table and certain actions that can be performed on certain elements identified in the listing table. For instance, the code section 306 in the example UI input section 304 identifies certain actions that can be performed on a “button” element identified in the listing UI screen. The code section 306 defines a “bastion” for the button element and code used to perform a “delete” operation on a button element in the listing UI page. A “bastion” as described herein may refer to a logical entity that can provide the user with a secure, public access to a target resource (e.g., a listing page) in the cloud that cannot otherwise be reached from the internet. For example, to delete a UI element such as a button, the code implemented in the code section describes a set of instructions that defines the logic and behavior of a delete operation implemented for the button element to remove it from a UI screen. The delete action described in the code section of the prompt template is intended to be illustrative in nature. For example, in other embodiments, the code section can describe various other types of operations (create, read update and so on) that can be performed on other types of UI elements identified in the UI screen. Additionally, the code section can incorporate code that can be used to define operation-specific workflows to test the logic of modal window behavior of UI elements in a UI screen, the presence of required columns, form creation and cancellation processes, API-level data validation through request and response header mocking, sorting functionality, table filters, modal dialogs, side panels, sub-resources, edit functionality in the UI screen to be tested and so on.

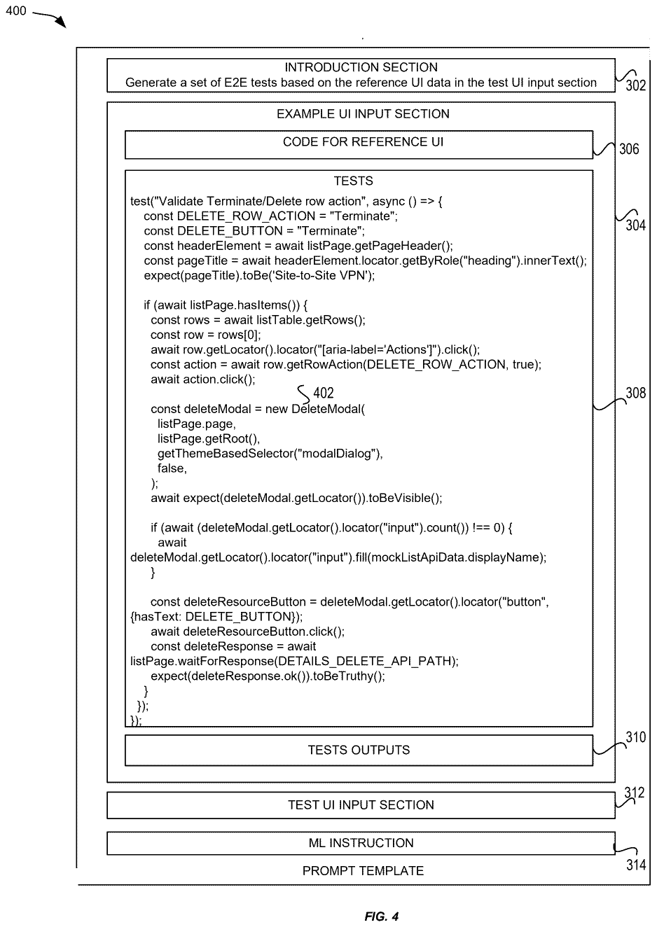

The example configuration for the prompt template shown in FIG. 3 additionally includes a tests section. The tests section 308 is part of the example UI input section 304 and specifies a set of one or more test cases written for the reference UI data. One such illustrative prompt template comprising a set of test cases written for reference UI data, where the reference UI data is associated with a listing UI screen is shown in FIG. 4. The specific configuration of the prompt template shown in FIG. 4 is intended to be illustrative in nature. For example, the specific content in the tests section 308 described in the prompt template may vary according to embodiments of the present application.

FIG. 4 illustrates an example configuration for a tests section in a prompt template that is used to generate a set of test cases for a UI screen to be tested, according to certain examples. In the example shown in FIG. 4, the tests section 308 in the prompt template 302 specifies a test case written for testing the reference UI data, where the reference UI data is associated with a listing UI screen. In certain implementations, the tests section 308 and the tests output section 310 in the prompt template may be combined together and used to specify a set of one or more test cases and identify the outputs from executing the one or more test cases. The specific test case and its output described in the prompt template shown in FIG. 4 for a listing UI screen is intended to be illustrative in nature. For example, in other embodiments, the prompt template can comprise different or additional types of test cases that can be written for reference data associated with a listing UI screen or test cases written for other types of UI screens described throughout this disclosure.

In the example shown in FIG. 4, the tests section 308 for the “listing UI screen” identifies a test case written to validate a “delete action” for a button displayed in the listing UI screen. For example, a test case written in the tests section 308 for a “delete action” for a button might describe a set of conditions or variables under which a user can determine whether the “delete action” is working correctly and according to its requirements. For instance, the test case can describe that the user has to navigate to the listing page, find the button the user wants to delete, select an actions menu and choose the “Delete” action to open a deletion modal. In the modal, the user has to select “Delete” to complete the delete action. The test case can further describe that if the button is not deleted, the confirmation dialog closes, and the user remains on the same screen.

Incorporation of Abstract Classes into a Prompt Template

In certain examples, the prompt template described in FIG. 3 and FIG. 4 may comprise a list of abstract classes that may be used to define the functionality and properties of related or common UI elements identified in the reference UI data. These abstract classes may be integrated into the tests section 308 in the example UI input section 304 of the prompt template. By integrating these abstract classes into the prompt template, the test case generation system 102 is able to easily adapt to evolving UI structures associated with services and applications within a distributed computing environment. For instance, in certain situations, certain UI elements in a UI screen may suddenly move around after content is already displayed, or UI elements may change when content (e.g. images, videos, fonts) loads in a UI screen at different times. These unexpected changes in the UI elements may cause the underlying HTML elements that are used to describe the structure of the UI elements to become unstable. HTML elements (also referred to herein as HTML Document Object Model (DOM) elements), in the context of a UI screen, may refer to programmatic representations that make up a web page or a UI screen. The DOM refers to a language-independent, cross-platform Application Programming Interface (API) that structures a HTML document as a tree of objects, where each HTML element, attribute, and text content becomes a node in the tree. Each visual or structural component in a UI screen that originates from HTML (e.g., a button, a paragraph of text, an image, a form input field) may be represented as a distinct HTML DOM element (or node) within a DOM tree.

The list of abstract classes enable the test case generation system 102 to easily manage UI elements identified in a UI screen, even when the UI elements are constantly evolving. Instead of referencing the HTML code used to represent the underlying structure of the UI elements in the reference UI screen, the test case generation system can directly reference the abstract classes defined in the test cases that define the functionality of the UI elements. Directly referencing HTML DOM elements may introduce instability especially in situations when the UI elements may dynamically change. In certain examples, the list of abstract classes may be imported by the test generation system 102 from an abstract class library 134 that is stored in the data store 122. For instance, the test case generation system 102 can obtain an abstract class to define common properties (e.g., text, color, position) and certain functionalities (e.g., onClick, onHover) that are shared across a group of related UI elements (e.g., across different types of buttons) identified in a UI screen. For instance, in the example described in FIG. 4, the tests section 308 comprises an abstract class 402 “DeleteModal( )” that can be used to perform a delete operation on a UI element (e.g., a button) identified in the UI screen. A definition of the “DeleteModal( )” abstract class is illustrated in example-1 below. The abstract class defines common properties and certain functionalities (e.g., a delete operation) that is shared across a group of related UI elements (e.g., across different types of buttons) identified in a UI screen. As previously indicated, the test case generation system 102 may obtain the abstract class definitions from the abstract class library 134 stored in the data store 122.

### Example-1

```
import { ModalDialog } from “./ModalDialog”;
export default class DeleteModal extends ModalDialog {
  getDeleteButton( ) {
    return this.getFooter( ).locator(“button.oui-button.oui-button-danger”);
  }
}
```

By defining the common functionality of UI elements displayed in a UI screen using an abstract class, the test case generation system can directly reference the abstract class to manage a set of HTML elements used to describe UI elements in UI screens instead of directly referencing the HTML DOM elements, which may introduce instability in the HTML DOM structure. Existing AI-based solutions often tend to misidentify UI elements in a web page (e.g., a UI screen) owing to such unstable HTML DOM structures. Some AI-based solutions attempt to directly reference the HTML DOM elements, but this causes instability, especially with dynamically changing custom UI structures. This, in turn, results in unreliable test cases being generated and increased manual validation efforts by the AI models. By incorporating abstract classes into the prompt template, the set of test cases that are generated by the test case generation system are able to dynamically adapt to evolving UI structures, thereby enabling more scalable, dynamic, and rapid, on-the-fly test case generation than what is possible by existing test generation techniques. In addition, the abstract classes serve as a stability layer for UI tests, ensuring resilience when web elements (UI elements) change. In certain implementations, the set of abstract classes may be implemented by the test case generation system 102 as a reusable layer, where the system can embed the abstract class definitions directly within prompt templates, instead of referencing them externally.

In certain examples, a selector for the stability layer may be implemented, The selector may be expressed illustratively as Stability(φ)=1−|Changes_in_Test_Cases|/|Changes_in_DOM_Structure|, where higher values indicate greater resilience to DOM modifications. This expression is provided for explanatory purposes only and does not limit the scope of the invention. In certain examples, the collection of abstract classes described above may be implemented as a reusable layer over various cloud services such as compute, database, network, and storage services.

As previously indicated, the example configuration for the prompt template shown in FIG. 3 and FIG. 4 additionally includes a test UI input section 312 and a ML task instruction section 314. The test UI input section 312 comprises source code for which E2E tests are to be generated for the UI screen to be tested. The ML task instruction section specifies an instruction outlining the requirements to the ML model for generating the test cases. For example, an instruction provided in the ML instruction section can be “Based on the code and the tests and test outputs provided in the example UI section, generate a set of E2E tests for the code identified in the test UI input section.”

Returning to the discussion in FIG. 2, at block 218, the prompt template generation subsystem provides the prompt generated in block 210 as input to a Machine Learning (ML) model. In a certain implementation, the ML model is a Large Language Model (LLM), although other types of ML models can be used in other implementations. At block 214, a test case execution platform 120 executes one or more tests output by the ML model in 218 to test the UI to be tested. In certain implementations, the test case execution platform 120 may represent a platform (e.g., Playwright) that serves as a robust platform for end-to-end test case execution, particularly for web applications. The results (i.e., a set of test cases executed for the UI screen 108) are then communicated back to the requesting user device or stored in the data store 122. These results (e.g., 128 as shown in FIG. 1) may include a set of test cases executed for the UI screen to be tested, and possibly other information such as an execution result for each executed test case such as whether the test passed, failed, or was inconclusive, along with detailed logs, captured evidence like screenshots or videos, error messages, and a summary of defects included in the results.

In certain implementations, the processing performed by the subsystems (e.g., 112, 114, 116, and 118) of the test case generation system 102 described in blocks 202-220 in FIG. 1 may be performed via a structured pipeline. The components of the pipeline may include for example, a file crawler component, a file reader component, a prompt compiler, prompt templates and an ML model (e.g., an LLM). For instance, a file crawler component which may be implemented within the subsystem 112 can be configured to scan the service and select all the files related to the UI screen to be tested from the final build, based on the category (e.g., listing UI, details UI, create/read UI, delete UI and so on) determined for the UI screen as described above. A file reader component within the subsystem 112 may be configured to fetch the contents of the individual files and provide them to a prompt compiler. The prompt compiler may be implemented within the subsystem 116 and may be configured to select a prompt template and populate the prompt template based on the category determined for the UI screen to be tested. The final prompt may be fed to an LLM which uses the provided prompt to generate appropriate E2E tests for the UI screen to be tested.

While the pipeline described above is sequential, in certain implementations, the file writer component may be configured to produce multiple test files asynchronously (1→n concurrent outputs), enabling scalable parallel test generation. In addition, in certain implementations, the test case generation system may be configured with capabilities to automatically categorize the files related to the UI screen to be tested according to the content in the UI screen during the crawling process. The categorization ensures the generation of customized prompts that can be used to generate test cases that are relevant and applicable for testing different UI screens of a service or application executing in a distributed computing environment.

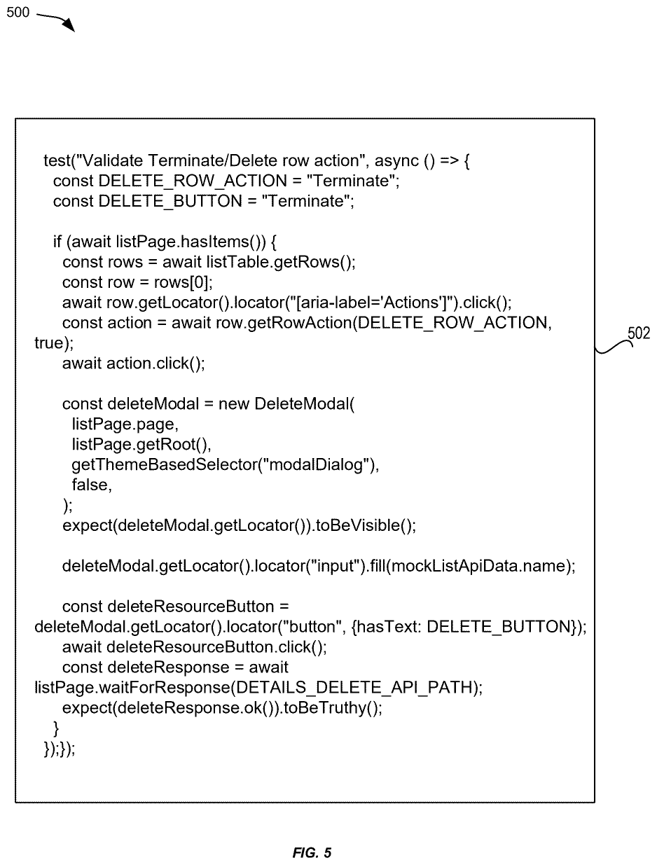

FIG. 5 illustrates an example of a test case generated by the ML model based on generating a prompt that is specific to a type of content in the UI screen being tested, according to certain embodiments. The specific configuration of the test case output by the ML model shown in FIG. 5 is intended to be illustrative in nature. For example, the specific content of the test case that is generated and output may vary according to embodiments of the present application. For example, FIG. 5 illustrates an example of a test case output by the ML model to validate a “delete action” for a button displayed in a listing UI screen. As previously described, a test case written in a tests section (e.g., 308) of a prompt template (e.g., 300) for a “delete action” for a button might describe a set of conditions or variables under which a user can determine whether the “delete action” is working correctly and according to its requirements. For instance, the test case can describe that the user has to navigate to the listing page, find the button the user wants to delete, select an actions menu and choose the “Delete” action to open a deletion modal. In the modal, the user has to select “Delete” to complete the delete action. The test case can further describe that if the button is not deleted, the confirmation dialog closes, and the user remains on the same screen.

### Experimental Results

In certain embodiments, to ensure the accuracy and reliability of the test results generated by the ML model, the execution result for each executed test case for the UI screen to be tested by the test case execution platform 128 was compared against predefined expected results (outputs) for each test case identified in the prompt used to generate the set of test cases. To test the accuracy of generating test cases using the single-shot, UI content-specific based prompting technique coupled with abstract-class-based referencing described above, experiments were conducted on 15 services with varying complexity. Test suits comprising approximately 924 test cases were validated for these services, and deployed into production, providing empirical evidence of the practical feasibility of the disclosed methodology. The validation results indicated that the proposed method drastically accelerated the test case generation, reducing a timeline of several days or weeks to only minutes or a single day.

Production-scale validation across 924 test cases on 15 Cloud Infrastructure services demonstrated 87% accuracy with 90% time reduction from conventional approaches. Test suites comprising 924 test cases were validated and 424 test cases were successfully deployed to production environments in the cloud infrastructure, providing empirical evidence of practical feasibility and industrial applicability. The abstract class library required an initial development investment of approximately 2-3 months. Once established, this reusable infrastructure enabled the disclosed single-shot, CRUD-specific prompting methodology to generate test cases in 1-4 hours, reducing several weeks of manual effort. The reusable abstract class library significantly improved development efficiency at enterprise scale, reducing per-service test generation from traditional timescales of weeks and for some services, even months, to 1-4 hours depending on service complexity using the proposed methodology, while maintaining 80-90% accuracy across all services within JSON-configuration architectures.

In certain implementations, a baseline comparison was conducted between manually written test cases and those generated via the disclosed AI-driven methodology using UI content-specific based prompting coupled with abstract-class-based referencing. These manual test cases were created by developers and served as a benchmark for evaluating the efficacy of the disclosed approach. The manually written test cases were assumed to be the fundamental standard reference and were used to compare the AI-written cases during the disclosed approach based on three benchmarks: (1) functional coverage, (2) logical accuracy, and (3) semantic alignment with business workflows. The AI-generated test cases were considered correct when they aligned with the intended logic and sequence of the manual versions, without hallucinations or redundant actions. The AI-generated tests exhibited greater comprehensiveness and coverage, addressing a broader range of scenarios when guided by business use cases.

A comparative analysis between the manual test case development and the proposed approach revealed a significant reduction in the required time for test case generation. Table-1 illustrated below shows results of the disclosed approach as compared to existing approaches for test generation. Specifically, the disclosed approach accelerated test case generation, reducing a timeline of several days or weeks to only minutes or a single day. In certain implementations, the system reduces test generation time from weeks or months to 1-4 hours per service depending on complexity while achieving 80-90% accuracy.

TABLE 1

| | | | | | | Token/ |
|---|---|---|---|---|---|---|
| | Avg. Test | | | Hallucination | Engineer | Compute |
| Method | Time/Service | | Accuracy | Risk | Effort | Cost |
| Manual/Template-based | 1-3 | weeks | ~90% | Low | High | N/A |
| CoT Prompting (multistep) | 7-9 | hours | 70%-83% | Medium-High | Medium | High |
| Disclosed technique | ~4 | hours | 80%-90% | Low | Low (1 | Low |
| | | | | | engineer) | |

The results from Table I indicate that the disclosed approach significantly enhanced the testing efficiency while maintaining competitive accuracy. Although template-based systems are precise, they require extensive manual engineering and are not resilient to frequent UI changes. CoT prompting automates test generation but suffers from high computational costs and instability, particularly owing to multistep reasoning and hallucinations in DOM references. Conversely, the disclosed approach balances generality with specificity, allowing for fast, low-latency generation of stable test cases and minimizing human intervention and resource consumption. The disclosed system was also validated in production-scale environments, demonstrating improved accuracy, faster test development cycles, and reduced engineering effort compared to conventional approaches. In certain implementations, the system was also able to generate executable test environments including mock data by analyzing example inputs and outputs from code under test, providing comprehensive executable tests rather than partial test scripts requiring additional configuration.

In certain examples, the ML model processes the prompt in a single operation, in contrast to chain-of-thought prompting approaches that require multiple sequential reasoning steps, thereby reducing reliance on chain-of-thought prompting and the associated computational overhead. In certain examples, the single-shot prompting approach operates with computational complexity of O(1×token_cost), in contrast to chain-of-thought prompting approaches that require O(n×token_cost×reasoning_steps). By avoiding multi-step reasoning, the system reduces computational overhead and dependence on expensive compute resources. The system further processes JSON-configuration-driven UI files that declaratively express UI structure and intent, which provides superior stability compared to approaches that scrape or directly reference rendered HTML DOM elements. By embedding abstract class definitions directly into prompt templates, the system aligns prompt engineering with CRUD-specific requirements and enables single-shot prompting with asynchronous file generation (1→n concurrent outputs). The same abstract class definitions enable the test generation across diverse cloud services including compute services, database services, networking services, and storage services. This approach produces predictable outputs under fixed prompting conditions while minimizing hallucination and reducing error propagation across diverse cloud services.

As previously described, existing approaches for performing test case generation lack structured abstraction mechanisms to accommodate evolving UI structures. In contrast, the disclosed technique incorporates abstract-class-based referencing and UI content-specific based prompting to address dynamic UI changes, reduce hallucination, and improve the accuracy of large-scale test generation across diverse cloud environments. Moreover, existing approaches that perform automatic E2E testing do not adequately address challenges such as hallucination arising from AI models that often tend to misidentify UI elements in UI structures, which results in the generation of test cases with lower accuracy. These approaches often rely on multi-step CoT prompting, which increases token cost, latency, and the risk of hallucination. In contrast the disclosed system uses Cread Read Update Delete (CRUD)-specific templates (e.g., based on the listing UI category, the details UI category, the create/update UI category, the delete UI category described herein) that produce correct results in a single model call. The system provides deterministic outputs and achieves significant reductions in computational cost and processing time compared to chain-of-thought prompting. The system is additionally capable of automatically classifying UI files by CRUD operations upon file crawl, reducing manual engineering effort through systematic classification compared to conventional approaches.

The single-shot, UI content-specific based prompting technique coupled with abstract-class-based referencing described above enables more robust and sustainable test cases to be generated in dynamic UI environments. In certain examples, the test case generation system is capable of producing multiple test files asynchronously (1→n concurrent outputs) from a sequential processing pipeline, enabling scalable parallel test generation across enterprise service portfolios. The disclosed method automates E2E UI test case generation using structured prompts, abstract-class-based selectors, and configuration-driven inputs to enhance execution stability and test coverage in cloud-native environments and distributed computing environments.

### Cloud Environments

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

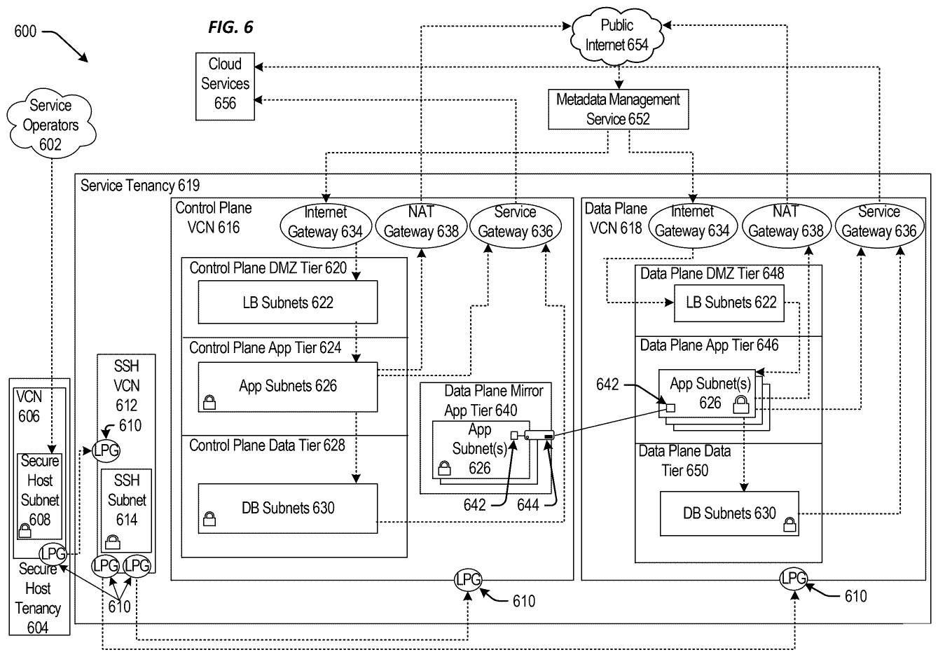

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively couple to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users', or other customers', resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

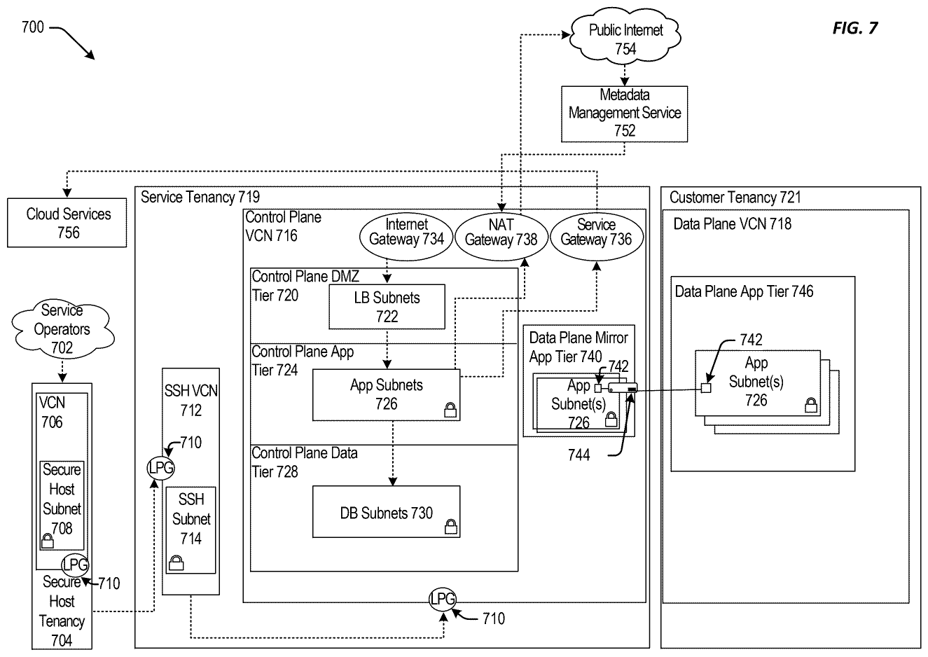

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively couple to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 6,” may be located in Region 1 and in “Region 2.” If a call to Deployment 6 is made by the service gateway 736 contained in the control plane VCN 716 located in Region 1, the call may be transmitted to Deployment 6 in Region 1. In this example, the control plane VCN 716, or Deployment 6 in Region 1, may not be communicatively coupled to, or otherwise in communication with, Deployment 6 in Region 2.

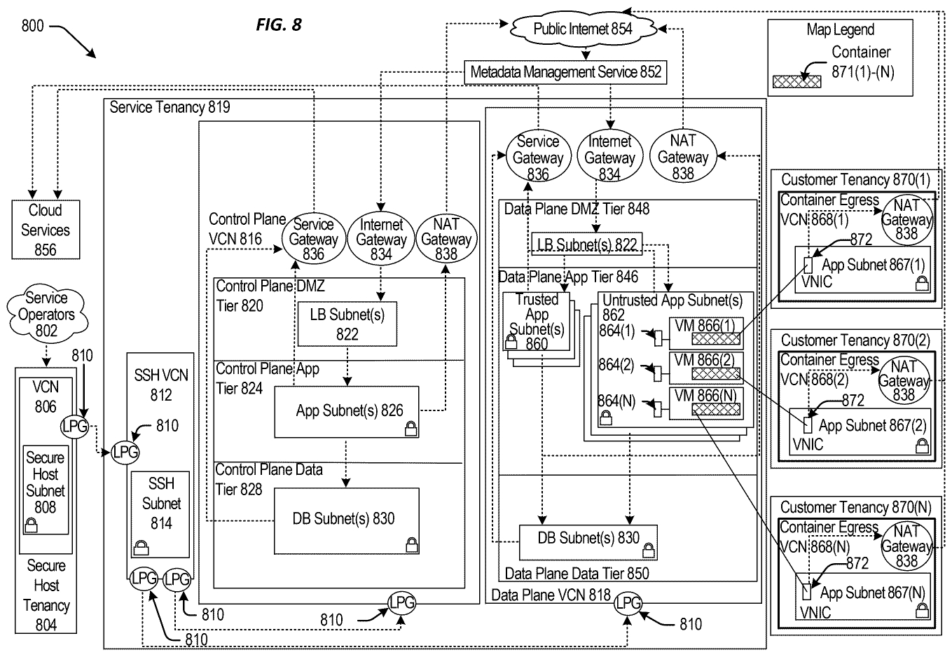

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

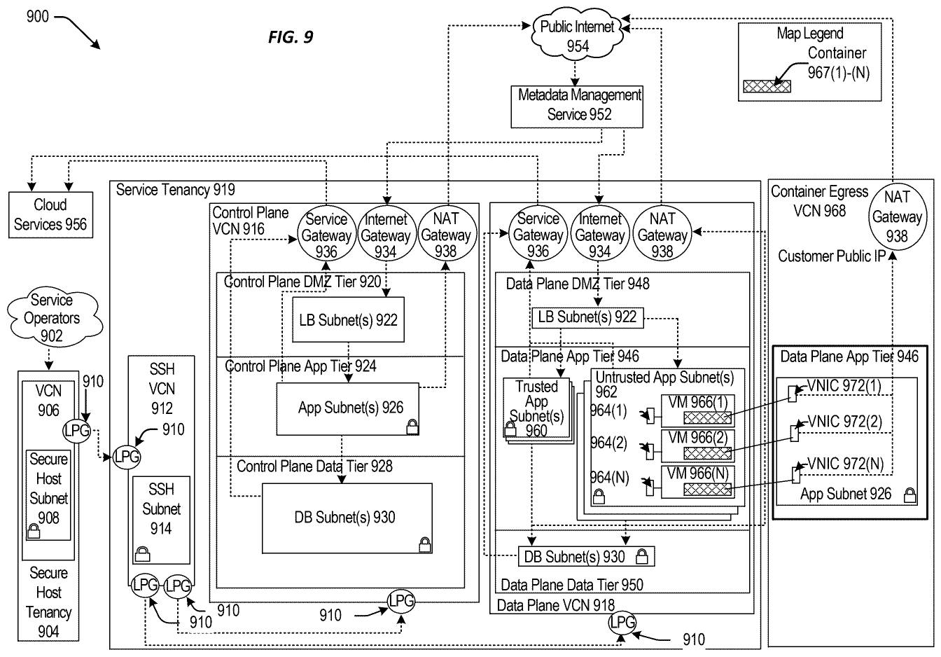

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

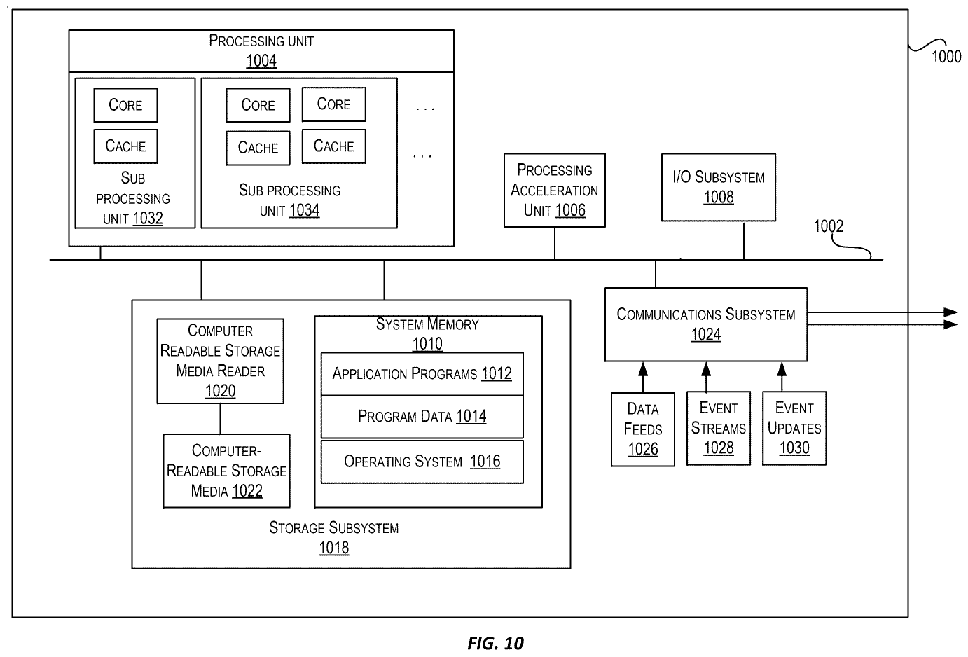

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that comprises software elements, shown as being currently located within a system memory 1010. System memory 1010 may store program instructions that are loadable and executable on processing unit 1004, as well as data generated during the execution of these programs.

Depending on the configuration and type of computer system 1000, system memory 1010 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1004. In some implementations, system memory 1010 may include multiple different types of memory, such as static random access memory (SRAM) or dynamic random access memory (DRAM). In some implementations, a basic input/output system (BIOS), containing the basic routines that help to transfer information between elements within computer system 1000, such as during start-up, may typically be stored in the ROM. By way of example, and not limitation, system memory 1010 also illustrates application programs 1012, which may include client applications, Web browsers, mid-tier applications, relational database management systems (RDBMS), etc., program data 1014, and an operating system 1016. By way of example, operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1018 may also provide a tangible computer-readable storage medium for storing the basic programming and data constructs that provide the functionality of some embodiments. Software (programs, code modules, instructions) that when executed by a processor provide the functionality described above may be stored in storage subsystem 1018. These software modules or instructions may be executed by processing unit 1004. Storage subsystem 1018 may also provide a repository for storing data used in accordance with the present disclosure.

Storage subsystem 1000 may also include a computer-readable storage media reader 1020 that can further be connected to computer-readable storage media 1022. Together and, optionally, in combination with system memory 1010, computer-readable storage media 1022 may comprehensively represent remote, local, fixed, and/or removable storage devices plus storage media for temporarily and/or more permanently containing, storing, transmitting, and retrieving computer-readable information.

Computer-readable storage media 1022 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1000.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
obtaining, by a test case generation system, a user interface (UI) screen to be tested;
determining, by the test case generation system, code for implementing the user interface (UI) screen;
determining, by the test case generation system, a category for the user interface (UI) screen based on content associated with the UI screen;
determining, by the test case generation system, reference user interface (UI) data corresponding to the category of the UI screen to be tested;
generating, by the test case generation system, a prompt to be used for generating a set of test cases for the user interface (UI) screen to be tested;
providing, by the test case generation system, the prompt as input to a machine learning (ML) model to generate a set of test cases for the user interface (UI) screen to be tested; and
causing, by the test case generation system, the execution of the set of test cases generated by the machine learning (ML) model to test the user interface (UI) screen to be tested, wherein the set of test cases are executed in a test execution platform.

2. The computer-implemented method of claim 1, wherein the reference user interface (UI) data is associated with a reference user interface (UI) screen, and wherein the reference user interface (UI) screen belongs to the category determined for the user interface (UI) screen to be tested.

3. The computer-implemented method of claim 1, wherein the reference user interface (UI) data is associated with a reference user interface (UI) screen, and wherein the reference user interface (UI) screen is different from the user interface (UI) screen to be tested.

4. The computer-implemented method of claim 3, wherein the reference user interface (UI) screen is associated with a first cloud service and the user interface (UI) screen to be tested is associated with a second cloud service, and wherein the first cloud service is different from the second cloud service.

5. The computer-implemented method of claim 4, wherein a category of the reference user interface (UI) screen corresponds to the category of the user interface (UI) screen to be tested, and wherein the category of the reference user interface (UI) screen corresponds to at least one of a listing user interface (UI) category, a details user interface (UI) category, a create/update user interface (UI) category or a delete user interface (UI) category.

6. The computer-implemented method of claim 4, wherein the first cloud service and the second cloud service represent one or more services subscribed to by a user of the test generation system.

7. The computer-implemented method of claim 3, wherein the reference user interface (UI) screen represents a first user interface (UI) screen associated with a first cloud service and the user interface (UI) screen to be tested represents a second user interface (UI) screen associated with the first cloud service, and wherein a category of the reference user interface (UI) screen corresponds to the category of the user interface (UI) screen to be tested.

8. The computer-implemented method of claim 1, wherein generating the prompt to be used for generating the set of test cases for the user interface (UI) screen to be tested comprises:
selecting, by the test case generation system, a prompt template, wherein the selected prompt template comprises an example user interface (UI) input section, a test user interface (UI) input section and a task request section.

9. The computer-implemented method of claim 8, wherein generating the prompt to be used for generating the set of test cases for the user interface (UI) screen to be tested further comprises:
inserting, by the test case generation system, the reference user interface (UI) data into the example user interface (UI) input section of the prompt template; and
inserting, by the test case generation system, the code for implementing the user interface (UI) screen to be tested into the test user interface (UI) input section of the prompt template.

10. The computer-implemented method of claim 8, wherein the example user interface (UI) input section comprises:
a code section comprising code implemented for the reference user interface (UI) data;
a tests section specifying a set of test cases for the reference user interface (UI) data, wherein the reference user interface (UI) data is associated with a reference user interface (UI) screen, and wherein the reference user interface (UI) screen belongs to the category determined for the user interface (UI) screen to be tested; and
a tests outputs section identifying outputs from executing the set of test cases in the tests section.

11. The computer-implemented method of claim 10, wherein the tests section in the example user interface (UI) input section of the prompt template comprises a list of abstract classes, wherein the list of abstract classes are embedded into the prompt template and define a functionality and one or more properties associated with one or more related user interface (UI) elements identified in the reference UI data.

12. A system comprising:
one or more processors;
a non-transitory computer-readable storage medium storing instructions which, when executed by the one or more processors, cause the system to:
obtain a user interface (UI) screen to be tested;
determine code for implementing the user interface (UI) screen;
determine a category for the user interface (UI) screen based on content associated with the UI screen;
determine reference user interface (UI) data corresponding to the category of the UI screen to be tested;
generate a prompt to be used for generating a set of test cases for the user interface (UI) screen to be tested;
provide the prompt as input to a machine learning (ML) model to generate a set of test cases for the user interface (UI) screen to be tested; and
cause the execution of the set of test cases generated by the machine learning (ML) model to test the user interface (UI) screen to be tested, wherein the set of test cases are executed in a test execution platform.

13. The system of claim 12, wherein the reference user interface (UI) data is associated with a reference user interface (UI) screen, and wherein the reference user interface (UI) screen belongs to the category determined for the user interface (UI) screen to be tested.

14. The system of claim 12, wherein the reference user interface (UI) data is associated with a reference user interface (UI) screen, and wherein the reference user interface (UI) screen is different from the UI screen to be tested.

15. The system of claim 14, wherein the reference user interface (UI) screen is associated with a first cloud service and the user interface (UI) screen to be tested is associated with a second cloud service, and wherein the first cloud service is different from the second cloud service.

16. The system of claim 12, wherein the instructions to generate the prompt to be used for generating the set of test cases for the user interface (UI) screen to be tested comprise instructions to:
select a prompt template, wherein the selected prompt template comprises an example user interface (UI) input section, a test user interface (UI) input section and a task request section;
insert the reference user interface (UI) data into the example user interface (UI) input section of the prompt template; and
insert the code for implementing the user interface (UI) screen to be tested into the test user interface (UI) input section of the prompt template.

17. The system of claim 12, wherein the example user interface (UI) input section comprises:
a code section comprising code implemented for the reference user interface (UI) data;
a tests section specifying a set of test cases for the reference user interface (UI) data, wherein the reference user interface (UI) data is associated with a reference user interface (UI) screen, and wherein the reference user interface (UI) screen belongs to the category determined for the user interface (UI) screen to be tested; and
a tests outputs section identifying outputs from executing the set of test cases in the tests section.

18. The system of claim 12, wherein the system generates a plurality of test cases asynchronously from a sequential processing pipeline.

19. A non-transitory computer-readable medium storing instructions executable by a computer system that, when executed by one or more processors of the computer system, cause the one or more processors to perform operations comprising:
obtaining a user interface (UI) screen to be tested;
determining code for implementing the user interface (UI) screen;
determining a category for the user interface (UI) screen based on content associated with the UI screen;
determining reference user interface (UI) data corresponding to the category of the UI screen to be tested;
generating a prompt to be used for generating a set of test cases for the user interface (UI) screen to be tested;
providing the prompt as input to a machine learning (ML) model to generate a set of test cases for the user interface (UI) screen to be tested; and
causing the execution of the set of test cases generated by the machine learning (ML) model to test the user interface (UI) screen to be tested, wherein the set of test cases are executed in a test execution platform.

20. The non-transitory computer-readable medium of claim 19, wherein the reference user interface (UI) data is associated with a reference user interface (UI) screen, and wherein the reference user interface (UI) screen belongs to the category determined for the user interface (UI) screen to be tested.
